(19) United States
(12) Patent Application Publication
(10) Pub. No.: US 2021/0232207 A1
(43) Pub. Date: Jul. 29, 2021

(54) SYSTEMS AND METHODS TO SYNCHRONIZE POWER STATES BETWEEN INFORMATION HANDLING SYSTEM AND DISPLAY DEVICE

(71) Applicant: Dell Products L.P., Round Rock, TX (US)

(72) Inventors: Srinivas KAMEPALLI, Austin, TX (US); Adolfo S. MONTERO, Pflugerville, TX (US)

(73) Assignee: Dell Products L.P., Round Rock, TX (US)

(21) Appl. No.: 16/775,499

(22) Filed: Jan. 29, 2020

(51) Int. Cl. G06F 1/3287; G06F 1/3234; G06F 1/3209; G06F 1/16; G06F 1/26

(52) U.S. Cl. CPC G06F 1/3287; G06F 1/3278; G06F 1/266; G06F 1/3209; G06F 1/1632; G06F 1/3265

(57) ABSTRACT

A system may include a power button, a communications interface, and a controller configured to monitor for user interaction with the power button and communicate a message via the communications interface to a second system in order to cause the second system to change of a power state of the second system responsive to the user interaction with the power button and monitor for an indication from the second system via the communications interface indicative of user interaction with a second power button of the second system and responsive to receipt of the indication from the second system indicative of user interaction with the second power button, cause a change of a power state of the system responsive to user interaction with a second power button.

### TECHNICAL FIELD

The present disclosure relates in general to information handling systems, and more particularly to methods and systems for synchronizing power states between an information handling system and one or more display devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In traditional implementations, a display device's power state may be maintained separately from an information handling system to which it is coupled. Thus, turning a display device on or off (e.g., by interacting with a power button) does not cause an information handling system to which it is coupled to turn on or off as well. Similarly, turning an information handling system on or off (e.g., by interacting with a power button) does not cause a display device to which it is coupled to turn on or off as well. Thus, even though a display device may not display video data when an information handling system to which is it is coupled is turned off, the display device may not completely power off, but rather it may go into a standby state and only power off after a predetermined inactivity timeout.

In addition, in some form factors of information handling systems and/or display devices, accessibility of a power button may be physically difficult for a user. Accordingly, it may be desirable to provide users with an ability to power down an information handling system having a difficult-to-reach power button by interacting with a power button of a display device coupled to the information handling system, and vice versa.

### SUMMARY

In accordance with the teachings of the present disclosure, the disadvantages and problems associated with powering on and off information handling systems and connected display devices may be reduced or eliminated.

In accordance with embodiments of the present disclosure, a system may include a power button, a communications interface, and a controller configured to monitor for user interaction with the power button and communicate a message via the communications interface to a second system in order to cause the second system to change of a power state of the second system responsive to the user interaction with the power button and monitor for an indication from the second system via the communications interface indicative of user interaction with a second power button of the second system and responsive to receipt of the indication from the second system indicative of user interaction with the second power button, cause a change of a power state of the system responsive to user interaction with a second power button.

In accordance with these and other embodiments of the present disclosure, a method may include monitoring for user interaction with a first power button of a first system and communicating a message via a communications interface to a second system in order to cause the second system to change of a power state of the second system responsive to the user interaction with the power button and monitoring for an indication from the second system via the communications interface indicative of user interaction with a second power button of the second system and responsive to receipt of the indication from the second system indicative of user interaction with the second power button, causing a change of a power state of the first system responsive to user interaction with a second power button.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to monitor for user interaction with a first power button of a first system and communicate a message via a communications interface to a second system in order to cause the second system to change of a power state of the second system responsive to the user interaction with the power button and monitor for an indication from the second system via the communications interface indicative of user interaction with a second power button of the second system and responsive to receipt of the indication from the second system indicative of user interaction with the second power button, cause a change of a power state of the first system responsive to user interaction with a second power button.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system comprising an information handling system and a display device, in accordance with embodiments of the present disclosure;

FIG. 2 illustrates a flow chart of an example method for power state control at a display device, in accordance with embodiments of the present disclosure; and

FIG. 3 illustrates a flow chart of an example method for power state control at an information handling system, in accordance with embodiments of the present disclosure.

### DETAILED DESCRIPTION

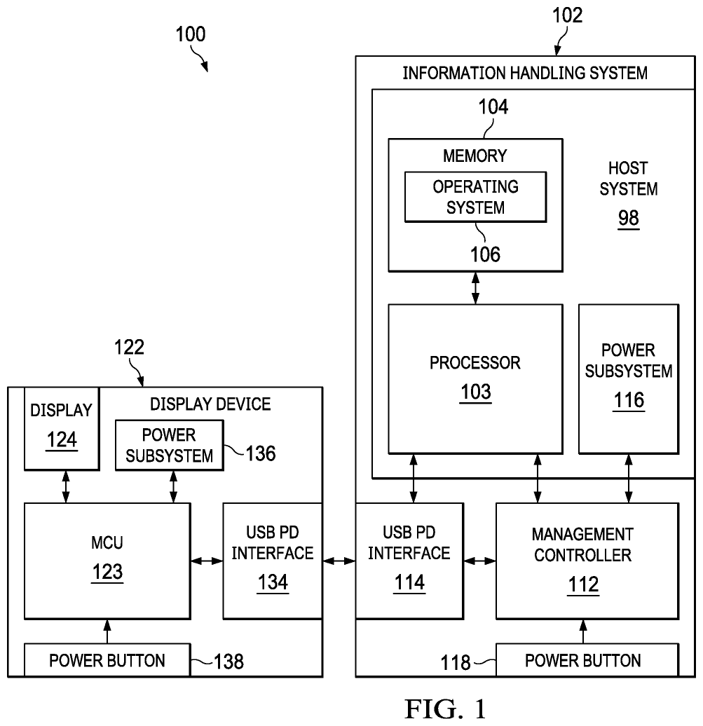

Preferred embodiments and their advantages are best understood by reference to FIGS. 1 through 3, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 comprising an information handling system 102 and a display device 122, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a management controller 112 communicatively coupled to processor 103, a Universal Serial Bus (USB) Power Delivery (PD) interface 114 communicatively coupled to processor 103 and management controller 112, a power subsystem 116 communicatively coupled to management controller 112, and a power button 118 communicatively coupled to management controller 112. In operation, processor 103 and memory 104 may comprise at least a portion of a host system 98 of information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Management controller 112 may be configured to provide management facilities for management of information handling system 102. Such management may be made by management controller 112 even if information handling system 102 is powered off or powered to a standby state. Management controller 112 may include a processor, a memory, and or other components, such as USB PD interface 114. In certain embodiments, management controller 112 may include or may be an integral part of an embedded controller (EC), baseboard management controller (BMC), or a remote access controller (e.g., a Dell Remote Access Controller or Integrated Dell Remote Access Controller).

USB PD interface 114 may comprise any suitable system, device, or apparatus configured to serve as a cable interface in accordance with the USB PD specification. Although FIG. 1 depicts a USB PD interface 114, in some embodiments, an analogous data communication interface in accordance with a different communication standard may be used. In these and other embodiments, USB PD interface 114 may be communicatively coupled to management controller 112 via an Inter-Integrated Circuit (I2C) communications bus.

Power subsystem 116 may comprise any suitable system, device, or apparatus configured to deliver electrical energy to one or more components of information handling system 102 in order to allow such components to function. Accordingly, power subsystem 116 may include any suitable combination and numbers of power supply units, energy storage devices (e.g., batteries), regulators, and electrical conduits (e.g., wires, traces).

Power button 118 may comprise any suitable system, device, or apparatus with which a user may interact to indicate a desire to power on or power off information handling system 102. Accordingly, power button 118 may comprise an electromechanical button, a virtual mechanical button, or any other suitable device.

In addition to processor 103, memory 104, and management controller 112, USB PD interface 114, power subsystem 116, and power button 118, information handling system 102 may include one or more other information handling resources. In addition, although FIG. 1 shows information handling system 102 configured as what many would consider a computing system, in some embodiments, information handling system 102 may include fewer components than that often seen in a computing system, and may comprise a device with less functionality, such a docking station or port replicator.

As depicted in FIG. 1, display device 122 may include a microcontroller unit (MCU) 123, a display 124 communicatively coupled to MCU 123, a USB PD interface 134 communicatively coupled to MCU 123, a power subsystem 136 communicatively coupled to MCU 123, and a power button 138 communicatively coupled to MCU 123.

MCU 123 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data.

Display 124 may include any system, device, or apparatus configured to generate graphical images and/or reproduce alphanumeric text for viewing by a user of information handling system 102, based on display data communicated to display 124 from information handling system 102. Display 124 may comprise a light-emitting diode display, liquid crystal display, and/or any other suitable display.

USB PD interface 134 may comprise any suitable system, device, or apparatus configured to serve as a cable interface in accordance with the USB PD specification. Although FIG. 1 depicts a USB PD interface 134, in some embodiments, an analogous data communication interface in accordance with a different communication standard may be used. In operation, USB PD interface 134 may be coupled to USB PD interface 114 by a suitable cable (e.g., a USB Type-C cable).

Power subsystem 136 may comprise any suitable system, device, or apparatus configured to deliver electrical energy to one or more components of display device 122 in order to allow such components to function. Accordingly, power subsystem 136 may include any suitable combination and numbers of power supply units, energy storage devices (e.g., batteries), regulators, and electrical conduits (e.g., wires, traces).

Power button 138 may comprise any suitable system, device, or apparatus with which a user may interact to indicate a desire to power on or power off display device 122. Accordingly, power button 138 may comprise an electromechanical button, a virtual mechanical button, or any other suitable device.

For clarity of exposition, FIG. 1 depicts only a single display device 122 communicatively coupled to information handling system 102. However, in some embodiments of system 100, system 100 may include a plurality of display devices 122 communicatively coupled to information handling system 102 (e.g., directly to information handling system 102 or in a daisy chain from display device 122 to display device 122).

As described in greater detail below, USB PD interface 114 and USB PD interface 134 may utilize a vendor-defined messaging (VDM) capability of USB-C/Type-C, along with functionality of MCU 123 to communicate via configuration channel (CC) pins of a USB PD connection between display device 122 and information handling system 102. Accordingly, information handling system 102 may be configured to synchronize one or more display devices 122 with the power state of information handling system 102. In addition, information handling system 102 may be configured to receive power state information from one or more display devices 122.

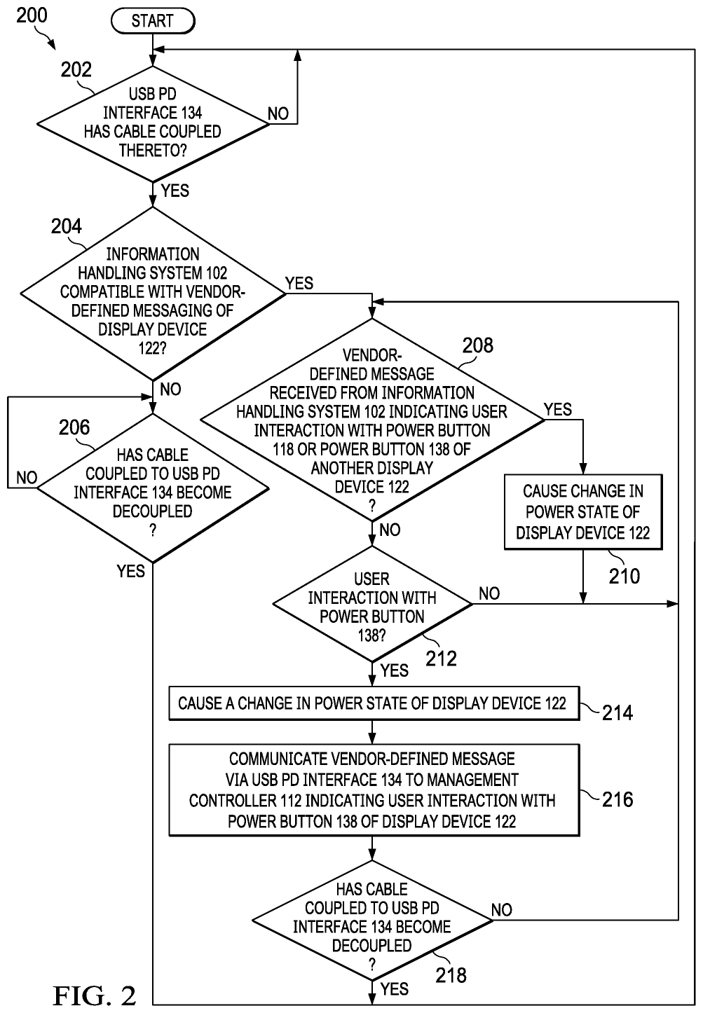

FIG. 2 illustrates a flow chart of an example method 200 for power state control at display device 122, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, MCU 123 may determine whether USB PD interface 134 has a cable coupled thereto. If no cable is detected, method 200 may remain at step 202. Otherwise, if a cable is detected, method 200 may proceed to step 204.

At step 204, MCU 123 may query information handling system 102, by querying management controller 112 via USB PD interface 134 (e.g., via CC pins), to determine if information handling system 102 is compatible with an ability of display device 112 to communicate vendor-defined messages for management of power state. If information handling system 102 is not compatible with an ability of display device 112 to communicate vendor-defined messages for management of power state, method 200 may proceed to step 206. Otherwise, if information handling system 102 is compatible with an ability of display device 112 to communicate vendor-defined messages for management of power state, method 200 may proceed to step 208.

At step 206, MCU 123 may determine whether a cable coupled to USB PD interface 134 has become decoupled therefrom. If the cable coupled to USB PD interface 134 remains coupled thereto, method 200 may remain at step 206 until the cable coupled to USB PD interface 134 has become decoupled therefrom. Otherwise, if a cable coupled to USB PD interface 134 has become decoupled therefrom, method 200 may proceed again to step 202.

At step 208, MCU 123 may determine if a vendor-defined message has been received from information handling system 102 indicating user interaction with power button 118 of information handling system 102 (or, in a multi-display device implementation, whether a vendor-defined message has been received from another display device 122 indicating user interaction with power button 138 of such other display device 138). If such a vendor-defined message has been received, method 200 may proceed to step 210. If such a vendor-defined message has not been received, method 200 may proceed to step 212.

At step 210, in response to receipt of a vendor-defined message has been received from information handling system 102 indicating user interaction with power button 118 of information handling system 102, MCU 123 may cause a change in power state of display device 122 as if its own power button 138 had received user interaction. After completion of step 210, method 200 may proceed again to step 208.

At step 212, MCU 123 may monitor for user interaction with power button 138. If user interaction with power button occurs, method 200 may proceed to step 214. Otherwise, in the absence of a user interaction with power button 138, method 200 may proceed again to step 208, and steps 208 and 212 may repeat until MCU 123 receives a vendor-defined message from information handling system 102 indicating user interaction with power button 118 of information handling system 102 or detects user interaction with power button 138.

At step 214, MCU 123 may cause a change in power state of display device 122 responsive to user interaction with power button 138. At step 216, also responsive to user interaction with power button 138, MCU 123 may communicate a vendor-defined message via USB PD interface 134 to management controller 112 indicating user interaction with power button 138 of display device 122.

At step 218, MCU 123 may determine whether a cable coupled to USB PD interface 134 has become decoupled therefrom. If the cable coupled to USB PD interface 134 remains coupled thereto, method 200 may proceed again to step 208. Otherwise, if a cable coupled to USB PD interface 134 has become decoupled therefrom, method 200 may proceed again to step 202.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using display device 122, MCU 123, and/or any other system operable to implement method 200. In certain embodiments, method 200 may be implemented partially or fully in software and/or firmware embodied in computer-readable media.

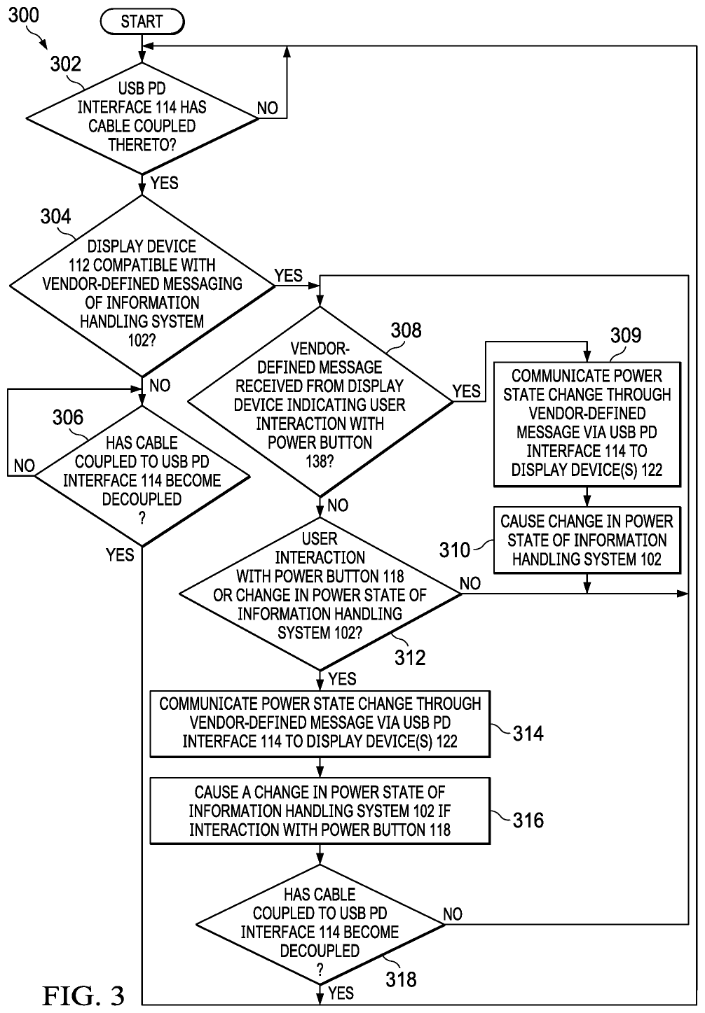

FIG. 3 illustrates a flow chart of an example method 300 for power state control at information handling system 102, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, management controller 112 may determine whether USB PD interface 114 has a cable coupled thereto. If no cable is detected, method 300 may remain at step 302. Otherwise, if a cable is detected, method 300 may proceed to step 304.

At step 304, management controller 112 may query display device 122, by querying MCU 123 via USB PD interface 114 (e.g., via CC pins), to determine if a display device 122 communicatively coupled to information handling system 102 is compatible with an ability of information handling system 102 to communicate vendor-defined messages for management of power state. If display device 122 is not compatible with an ability of information handling system 102 to communicate vendor-defined messages for management of power state, method 300 may proceed to step 306. Otherwise, if display device 122 is compatible with an ability of information handling system 102 to communicate vendor-defined messages for management of power state, method 300 may proceed to step 308.

At step 306, management controller 112 may determine whether a cable coupled to USB PD interface 114 has become decoupled therefrom. If the cable coupled to USB PD interface 114 remains coupled thereto, method 300 may remain at step 306 until the cable coupled to USB PD interface 114 has become decoupled therefrom. Otherwise, if a cable coupled to USB PD interface 114 has become decoupled therefrom, method 300 may proceed again to step 302.

At step 308, management controller 112 may determine if a vendor-defined message has been received from display device 122 indicating user interaction with power button 138 of display device 122. If such a vendor-defined message has been received, method 300 may proceed to step 310. If such a vendor-defined message has not been received, method 300 may proceed to step 312.

At step 309, in response to receipt of a vendor-defined message has been received from a display device 122 indicating user interaction with power button 138 of display device 122, management controller 112 may communicate a power state change through a vendor-defined message via USB PD interface 114 to MCUs 123 of one or more other coupled display devices 122 indicating user interaction with a power button 138 of another coupled display device 122.

At step 310, also in response to receipt of a vendor-defined message has been received from display device indicating user interaction with power button 138 of display device 122, management controller 112 may cause a change in power state of information handling system 102 as if its own power button 118 had received user interaction. After completion of step 310, method 300 may proceed again to step 308.

At step 312, management controller 112 may monitor for user interaction with power button 108 (or, in embodiments in which system 200 comprises a plurality of compatible display devices 122, determine if a power state of information handling system 102 has changed responsive to a vendor-defined message from display device 122, such as at the previous execution of step 310). If user interaction with power button 118 occurs (or, in embodiments in which system 200 comprises a plurality of compatible display devices 122, if a power state of information handling system 102 has changed responsive to a vendor-defined message from display device 122), method 300 may proceed to step 314. Otherwise, in the absence of a user interaction with power button 138 (or absence of a change to the power state of information handling system 102), method 300 may proceed again to step 308, and steps 308 and 312 may repeat until management controller 112 receives a vendor-defined message from information handling system 102 indicating user interaction with power button 118 of information handling system 102 or detects user interaction with power button 138.

At step 314, responsive to user interaction with power button 118 (or a change in power state responsive to a vendor-defined message from display device 122), management controller 112 may communicate a power state change through a vendor-defined message via USB PD interface 114 to MCUs 123 of one or more coupled display devices 122 indicating user interaction with power button 118 of information handling system 102. At step 316, also responsive to user interaction with power button 118, management controller 112 may cause a change in power state of information handling system 102.

At step 318, management controller 112 may determine whether a cable coupled to USB PD interface 114 has become decoupled therefrom. If the cable coupled to USB PD interface 114 remains coupled thereto, method 300 may proceed again to step 308. Otherwise, if a cable coupled to USB PD interface 114 has become decoupled therefrom, method 300 may proceed again to step 302.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using information handling system 102, management controller 112, and/or any other system operable to implement method 300.

In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a power button;
a communications interface; and
a controller configured to:
monitor for user interaction with the power button and communicate a message via the communications interface to a second system in order to cause the second system to change of a power state of the second system responsive to the user interaction with the power button; and
monitor for an indication from the second system via the communications interface indicative of user interaction with a second power button of the second system and responsive to receipt of the indication from the second system indicative of user interaction with the second power button, cause a change of a power state of the system responsive to user interaction with a second power button.

2. The system of claim 1, wherein the system is an information handling system and the second system is a display device communicatively coupled to the information handling system.

3. The system of claim 2, wherein the controller is a management controller of the information handling system.

4. The system of claim 1, wherein the system is a display device and the second system is an information handling system communicatively coupled to the display device.

5. The system of claim 1, wherein the second system is coupled to the communications interface of the system via a cable.

6. The system of claim 1, wherein the communications interface is compatible with Universal Serial Bus Power Delivery standard.

7. The system of claim 1, wherein the system is an first display device and the second system is a second display device communicatively coupled to the information handling system.

8. A method comprising:
monitoring for user interaction with a first power button of a first system and communicating a message via a communications interface to a second system in order to cause the second system to change of a power state of the second system responsive to the user interaction with the power button; and
monitoring for an indication from the second system via the communications interface indicative of user interaction with a second power button of the second system and responsive to receipt of the indication from the second system indicative of user interaction with the second power button, causing a change of a power state of the first system responsive to user interaction with a second power button.

9. The method of claim 8, wherein the first system is an information handling system and the second system is a display device communicatively coupled to the information handling system.

10. The method of claim 8, wherein the first system is a display device and the second system is an information handling system communicatively coupled to the display device.

11. The method of claim 8, wherein the second system is coupled to the communications interface of the system via a cable.

12. The method of claim 8, wherein the communications interface is compatible with Universal Serial Bus Power Delivery standard.

13. The method of claim 8, wherein the first system is an first display device and the second system is a second display device communicatively coupled to the information handling system.

14. An article of manufacture comprising:
a non-transitory computer-readable medium; and
computer-executable instructions carried on the computer-readable medium, the instructions readable by a processor, the instructions, when read and executed, for causing the processor to:
monitor for user interaction with a first power button of a first system and communicate a message via a communications interface to a second system in order to cause the second system to change of a power state of the second system responsive to the user interaction with the power button; and
monitor for an indication from the second system via the communications interface indicative of user interaction with a second power button of the second system and responsive to receipt of the indication from the second system indicative of user interaction with the second power button, cause a change of a power state of the first system responsive to user interaction with a second power button.

15. The article of claim 14, wherein the first system is an information handling system and the second system is a display device communicatively coupled to the information handling system.

16. The article of claim 14, wherein the first system is a display device and the second system is an information handling system communicatively coupled to the display device.

17. The article of claim 14, wherein the second system is coupled to the communications interface of the system via a cable.

18. The article of claim 14, wherein the communications interface is compatible with Universal Serial Bus Power Delivery standard.

19. The article of claim 14, wherein the first system is an first display device and the second system is a second display device communicatively coupled to the information handling system.
